(19) United States
(12) Patent Application Publication
(10) Pub. No.: US 2010/0028767 A1
(43) Pub. Date: Feb. 4, 2010

(54) STACKED SECONDARY BATTERY AND METHOD OF MANUFACTURING THE SAME

(75) Inventors: Tsuyoshi Inose, Sendai-shi (JP); Takao Daidoji, Sendai-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NEC TOKIN CORPORATION, Sendai-shi (JP)

(21) Appl. No.: 12/511,264

(22) Filed: Jul. 29, 2009

(30) Foreign Application Priority Data
Jul. 31, 2008 (JP) 2008-197773

(51) Int. Cl. H01M 4/02; H01M 4/82

(52) U.S. Cl. 429/128; 29/623.2

(57) ABSTRACT

A stacked secondary battery is formed by laying plate-shaped positive electrodes and plate-shaped negative electrodes one on the other by way of separators, wherein a collector is disposed at the front end of the end facet of each of the positive electrodes or the negative electrodes as viewed in a direction orthogonal relative to the stacking direction and has an active substance layer formed on the collector by applying slurry of particles of an active substance with a gap separating it from the front end or the electrode active substance layer is made to show a thickness varying from the front end toward the inside.

### CROSS-REFERENCE TO RELATED APPLICATIONS

This application is based upon and claims the benefit of priority from prior Japanese Patent Application No. 2008-197773, filed Jul. 31, 2008, the entire contents of which are incorporated herein by reference.

### BACKGROUND OF THE INVENTION

The present invention relates to a stacked secondary battery formed by sealing battery element including a multilayer structure prepared by laying flat plate-shaped positive electrodes and also flat plate-shaped negative electrodes one on the other by way of separators.

Lithium ion batteries are being broadly employed for portable equipment designed to be driven by a battery such as mobile phones because lithium ion batteries have a large charge/discharge capacity. Additionally, there is a large demand for high efficiency secondary batteries that can find applications in the field of electric vehicles, electric bicycles, electric tools and power storages.

Stacked batteries prepared by laying flat plate-shaped positive electrodes and flat plate-shaped negative electrodes one on the other by way of separators are broadly being employed in such high-output power batteries. Positive electrodes prepared by applying lithium transition metal complex oxide particles to aluminum foil that operates as a collector with an electric-conductivity providing material such as carbon black are employed in lithium ion batteries.

On the other hand, negative electrodes prepared by applying slurry of carbon particles and an electric-conductivity providing material such as carbon black to copper foil that operates as collector are employed there.

Each of the plate-shaped positive electrodes and the plate-shaped negative electrodes is prepared by applying an electrode active substance to a predetermined area of a strip of aluminum foil or copper foil that operates as a collector and subsequently punching out the electrode including a part where an active substance layer for connecting a tub for electroconductive connection is not formed.

Since each of the positive electrodes and the negative electrodes is formed by applying slurry produced by dispersing the solid ingredient into organic solvent and drying the slurry, undulations can be produced at the end facets of the metal foil and those of the active substance layer when the electrode is punched out.

Additionally, such a punching process provides an advantage that electrode can be cut out to show a predetermined profile in a short period of time, it is accompanied by a problem that it is difficult to accurately punch out the electrode by a single punching operation because the part thereof where the active substance is applied and the part thereof where no active substance is applied show a difference of thickness. In other words, the punched out electrode needs to be subjected to a manual finishing process that is performed by an operator.

On the other hand, methods of manufacturing lithium secondary batteries wherein each negative electrode is prepared by forming amorphous silicon thin film on a collector of copper foil and subsequently cutting the copper foil by means of a laser have been proposed and JP-A-2002-289180 describes such a method. According to the descriptions of such methods, the use of a laser for cutting copper foil can reduce production of burrs and distortions if compared with the use of a cutter for mechanically cutting copper foil.

For a stacked secondary battery such as a stacked lithium ion battery in which plate-shaped positive electrodes and plate-shaped negative electrodes are laid one on the other by way of separators, it is a problem to make the battery show excellent charging/discharging characteristics without increasing self discharges that take place due to the positive electrode active substance and/or the negative electrode active substance coming off from the positive electrodes and/or the negative electrodes, whichever appropriate.

Thus, an object of the present invention is to provide a stacked secondary battery such as a stacked lithium ion battery in which plate-shaped positive electrodes and plate-shaped negative electrodes are laid one on the other by way of separators that excellently radiates the heat generated in charging and discharging operations and also the heat applied externally and is free from degradation of the charging/discharging characteristics thereof due to wrinkles produced to the separators by repeated charging and discharging operations that give rise to expansions and contractions.

### SUMMARY

According to the present invention, the above object is achieved by providing a stacked secondary battery formed by laying plate-shaped positive electrodes and plate-shaped negative electrodes one on the other by way of separators, wherein a collector is disposed at the front end of the end facet of each of the positive electrodes or the negative electrodes as viewed in a direction orthogonal relative to the stacking direction and has an active substance layer formed on the collector by applying slurry of particles of an active substance with a gap separating it from the front end or the electrode active substance layer is made to show a thickness varying from the front end toward the inside.

Alternatively, in a stacked secondary battery as defined above, the collector may have active substance layers formed on the opposite surfaces with a gap separating them from the front end or the electrode active substance layer may be made to show a thickness varying from the front end toward the inside.

Still alternatively, in a stacked secondary battery as defined above, a molten and solidified section may be formed on an outer peripheral part of the active substance layer as viewed in a direction orthogonal relative to the stacking direction.

According to the present invention, there is also provided a method of manufacturing a stacked secondary battery including:

forming at least either plate-shaped positive electrodes or plate-shaped negative electrodes by

forming an electrode active substance layer on each of the electrodes by applying an electrode active substance to a metal foil having a surface area greater than the surface of the electrode;

subsequently cutting the metal foil by irradiating a laser beam; and

removing a part of the electrode active substance layer running along the cut end facet of the metal foil by means of a thermal effect of the laser beam to form a molten and solidified section of the electrode active substance;

subsequently laying the plate-shaped positive electrodes and the plate-shaped negative electrodes by way of separators; and

sealing the stacked secondary battery.

Alternatively, a laser beam may be irradiated only from one of the opposite sides of the electrode to remove a part of the electrode active substance layer running along the cut end facet of the metal foil toner image form molten and solidified sections of the electrode active substance on the respective surfaces of the electrode.

In a stacked secondary battery formed by laying plate-shaped positive electrodes and plate-shaped negative electrodes one on the other by way of separators according to the present invention, a collector is disposed at the front end of the end facet of each of the positive electrodes or the negative electrodes as viewed in a direction orthogonal relative to the stacking direction and has an active substance layer formed on the collector by applying slurry of particles of an active substance with a gap separating it from the front end or the active substance layer is made to show a thickness varying from the front end of the collectors toward the inside. Thus, according to the present invention, it is possible to provide a stacked secondary battery in which the cut end facet of each of the electrodes is smooth and the active substance adheres to the collector with large adhering force so as to make the battery show excellent charging/discharging characteristics. Additionally, the active substance of the battery is prevented from coming off to a large extent because of the one or two molten and solidified sections formed in an outer peripheral part of the active substance layer of each electrode.

### BRIEF DESCRIPTION OF THE DRAWINGS

The invention will be described with reference to the accompanying drawings, wherein like numbers reference like elements.

FIG. 1 is a schematic illustration of an embodiment of stacked secondary battery according to the present invention;

FIGS. 2A through 2C are schematic illustrations of an embodiment of method of manufacturing a stacked secondary battery according to the present invention;

FIG. 3 is an optical micrograph showing a cross-sectional view of a positive electrode of Example 1 according to the present invention;

FIG. 4 is an optical micrograph showing a cross-sectional view of a positive electrode of Example 2 according to the present invention;

FIG. 5 is an optical micrograph showing a cross-sectional view of a positive electrode of Comparative Example 1 according to the present invention;

FIG. 6 is an optical micrograph showing a cross-sectional view of a positive electrode of Example 3 according to the present invention;

FIG. 7 is an optical micrograph showing a cross-sectional view of a negative electrode of Example 5 according to the present invention; and

FIG. 8 is an optical micrograph showing a cross-sectional view of a negative electrode of Comparative Example 3 according to the present invention.

### DESCRIPTION OF EXEMPLARY EMBODIMENTS

The inventors of the present invention found that a stacked secondary battery that shows excellent charging/discharging characteristics can be provided by laying plate-shaped positive electrodes and plate-shaped negative electrodes one on the other by way of separators, when a collector is disposed at the front end of the end facet of each of the positive electrodes or the negative electrodes as viewed in a direction orthogonal relative to the stacking direction and has an active substance layer formed on the collector by applying slurry of particles of an active substance with a gap separating it from the front end or the active substance layer is made to show a thickness varying from the front end toward the inside.

The inventors of the present invention also found that the positive electrode active substance or the negative electrode active substance located at the ends of the positive electrodes or the negative electrodes, whichever appropriate, as viewed in a direction orthogonal relative to the plane for stacking the electrodes hardly comes off when an electrode active substance layer is formed on each of the electrodes by applying an electrode active substance to a metal foil having a surface area greater than the surface of the electrode and subsequently the metal foil is cut to the predetermined size of the positive electrode or the negative electrode, whichever appropriate, by irradiating a laser beam only from one of the opposite sides of the electrode because the positive electrode active substance or the negative electrode active substance, whichever appropriate, is removed not only from the surface where the laser beam is irradiated but also from the opposite surface in an area located near the cut section to produce areas located close to the end of the electrode as viewed in a direction orthogonal to the plane for stacking the positive electrodes or the negative electrodes, whichever appropriate, where neither a positive electrode active substance layer nor a negative electrode active substance layer exists or the positive electrode active substance layers or the negative electrode active substance layers, whichever appropriate, are made to show a thickness varying from the front end toward the inside.

Furthermore, molten and solidified sections are formed in the active substance layer at the boundary of the part where the active substance layer is removed by irradiation of a laser beam as the active substance is molten and then solidified by heat there so that the active substance layer adheres to the collector with large adhering force to make particles of the active substance hardly come off from the end facet.

Now, the present invention will be described further by referring to the accompanying drawings.

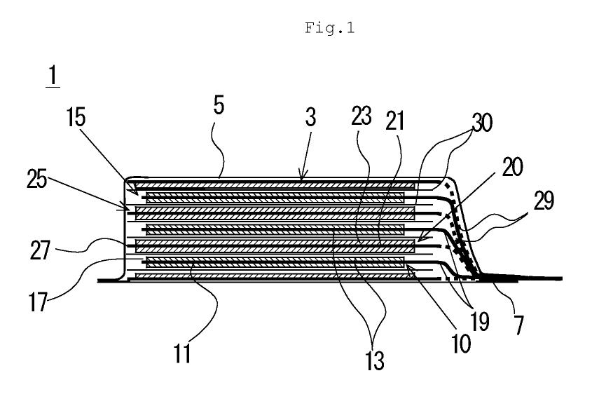

FIG. 1 is a schematic illustration of an embodiment of stacked secondary battery according to the present invention.

The stacked secondary battery 1 is typically a lithium ion battery having battery element 3 contained in a sealed film casing 5. The battery element 3 include positive electrodes 10 and negative electrodes 20 laid one on the other by way of separators 30.

Each of the positive electrodes 10 has a positive electrode active substance layer 13 formed on a positive electrode collector 11 that is typically made of aluminum foil. Each of the negative electrodes 20, which has a surface area greater than each of the positive electrodes 10, has a negative electrode active substance layer 23 formed on a negative electrode collector 21 that is typically made of copper foil.

Positive electrode draw-out terminals 19 and negative electrode draw-out terminals 29 are drawn out to the outside and bonded to the seal section 7 of the film casing 5 as a result of heat-sealing. The film casing 5 is sealed in a decompressed internal condition after electrolyte is injected in the inside thereof and the film casing is made to tightly adhere to the battery element due to the pressure difference between the outside and the inside of the secondary battery that is produced by the decompressed condition.

The stacked secondary battery shown in FIG. 1 is characterized in that each of the end sections 17 of the positive electrode collectors 11 is located in an area 15 of the battery located close to the end of the positive electrode in question as viewed in a direction orthogonal to the plane for stacking the positive electrodes and no positive electrode active substance layer 13 exists in that area 15 and the positive electrode active substance layers 13 have a small thickness at the end sections thereof.

On the other hand, the stacked secondary battery is also characterized in that each of the end sections 27 of the negative electrode collectors 21 is located in an area 25 of the battery close to the end of the electrode in question as viewed in the direction orthogonal to the plane for stacking the negative electrodes 20 and no negative electrode active substance layer 23 exists in that area 25 and the negative electrode active substance layers 23 have a small thickness at the end sections thereof.

Additionally, a molten and solidified section is formed at an end section of each of the positive electrode active substance layers and the negative electrode active substance layers as viewed in a direction orthogonal relative to the stacking direction thereof as a result of that the positive electrode active substance layers and the negative electrode active substance layers are partly molten due to irradiation of a laser beam and subsequently solidified so that particles of the active substance layers are made to firmly adhere to each other and also to the related respective collectors with large adhering force.

Then, consequently, the positive electrode active substance is prevented from coming off from the end sections of the positive electrodes as viewed in a direction orthogonal relative to the stacking direction of the positive electrodes to move toward the opposite polarity side. Similarly the negative electrode active substance is prevented from coming off from the end sections of the negative electrodes as viewed in a direction orthogonal relative to the stacking direction of the negative electrodes to move toward the opposite polarity. Thus, a stacked secondary battery according to the present invention can effectively prevent the battery characteristics from being degraded by self discharges that take place due to the positive electrode active substance and the negative electrode active substance coming off respectively from the positive electrodes and the negative electrodes.

While the separators are open at the opposite ends in the embodiment of FIGS. 1A through 1C, pouch-like separators containing positive electrodes or negative electrodes may alternatively be employed.

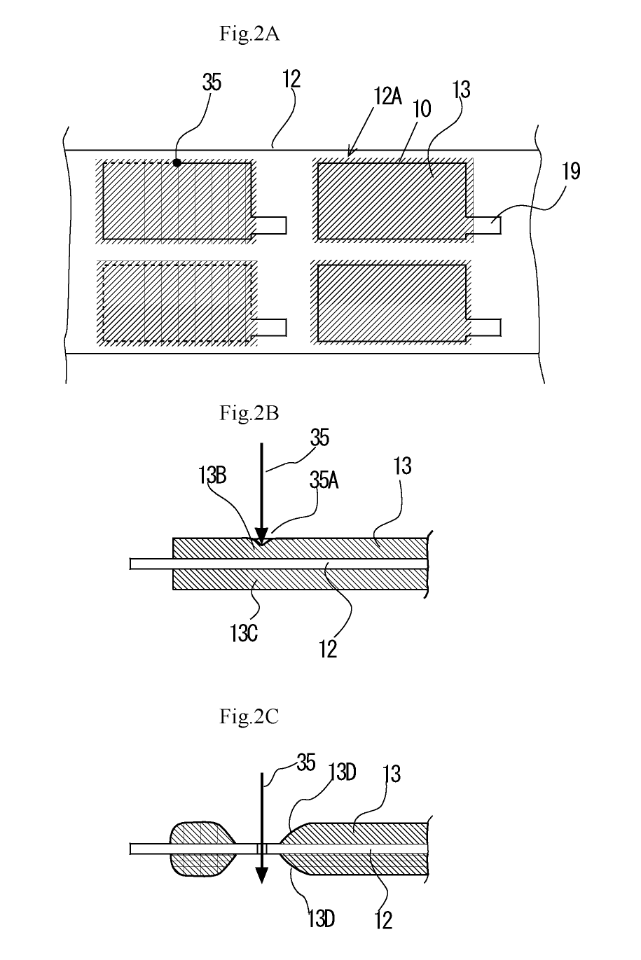

FIGS. 2A through 2C are schematic illustrations of an embodiment of method of manufacturing a stacked secondary battery according to the present invention. More specifically, FIGS. 2A through 2C illustrate how positive electrodes are formed according to the present invention. FIG. 2A is a schematic plan view of a stacked secondary battery according to the present invention and FIGS. 2B and 2C show a cross-sectional view of a positive electrode at a part that is irradiated with a laser beam.

As shown in FIG. 2A, slurry of a positive electrode active substance is applied to an area 12A of a positive electrode collector base member 12 that is greater than the area for forming positive electrodes and dried. Subsequently, a laser beam 35 is irradiated onto the base member 12 along the outer boundary line of the positive electrode draw-out terminal 19 of each positive electrode 10 that is integral with the latter to cut out a collector and a positive electrode active substance layer 13.

As the laser beam 35 is irradiated, the positive electrode active substance layer 13 is lost by abrasion from the surface 35A that is irradiated with a laser beam and eventually the aluminum foil of the positive electrode collector base member 12 is cut as shown in the cross-sectional views of FIGS. 2B and 2C.

At this time, it is possible to make the positive electrode active substance layer 13C at the side opposite to the side of the surface 35A that is irradiated with a laser beam also to be lost from the cut line and its vicinity with the positive electrode active substance layer 13B of the side of the surface 35A that is irradiated with a laser beam by adjusting the intensity of the irradiated laser beam, the spot diameter and the relative moving speed of the laser beam and the positive electrode active substance.

Thus, only the positive electrode collector 11 is found at the end of the positive electrode as viewed in a direction orthogonal relative to the stacking direction of the positive electrodes when the cutting conditions of the laser beam are adjusted appropriately in a manner as described above. Additionally, the positive electrode active substance layer 13 is partly lost under the effect of the laser beam and the thickness of the positive electrode active substance layer 13 is gradually decreased toward the end of the positive electrode collector 11.

Still additionally, a molten and solidified section 13D is produced as the positive electrode active substance layer is molten by the thermal effect of the laser beam and subsequently solidified so that the positive electrode active substance layer is made to adhere to the collector of the base member more firmly and prevented from coming off from the latter.

While how to prepare positive electrodes is described above, negative electrodes can also be prepared in a similar manner.

In the case of a lithium ion battery, a positive electrode active substance layer is formed by applying slurry containing lithium manganese complex oxide, lithium cobalt complex oxide or lithium nickel complex oxide as a principal ingredient to aluminum foil that operates as a collector for each positive electrode. A negative electrode active substance layer formed by applying slurry containing carbon particles as a principal ingredient to copper foil that operates as a collector is used for each negative electrode.

Since the effect of a laser beam is influenced by the beam absorption rate and the thermal conductivity, the laser output, the relative moving speed of the laser beam and the positive electrode to be cut by the laser beam and the beam diameter should be adjusted appropriately for the positive electrodes of a stacked secondary battery.

Furthermore, the amount of heat can become excessive to produce scars of melting that by turn give rise to undulations on the cut facet when the electrode is exposed to a laser beam too long. Therefore, it is recommendable to move the part to be cut and the laser machining head relative to each other for a plurality of times when irradiating a laser beam to cut a collector.

### EXAMPLE 1

Slurry was prepared from 63 mass portions of a lithium manganese complex oxide having a number average particle diameter of 15 micrometer, 4.2 mass portions of acetylene black having a number average particle diameter of 7 micrometer, 2.8 mass portions of polyvinylidene fluoride and 30 mass portions of N-methyl-2-pyrrolidone.

The slurry was then applied to an aluminum foil having a thickness of 20 micrometer-thick and a width of 150 mm-wide that is used for collector intermittently across the entire width of the foil to produce 20 mm-long unapplied parts and 130 mm-long applied parts. Then, the slurry was dried to produce a 180 micrometer-thick positive electrode active substance layer.

A laser beam was irradiated onto the aluminum foil by means of a YAG laser of a laser wavelength of 1,060 nm under irradiation conditions including a spot diameter of 12 micrometer, a laser output of 20 W and a laser overlapped frequency of 20 kHz to 100 kHz so as to form an electrode draw-out terminal having a width of 13 mm and a length of 17 mm on each of the unapplied part. The aluminum foil was cut under the condition of relative moving speed of 20 mm/sec of the laser beam and the positive electrode active substance layer to produce positive electrodes with an application width of 65 mm and an application length of 125 mm.

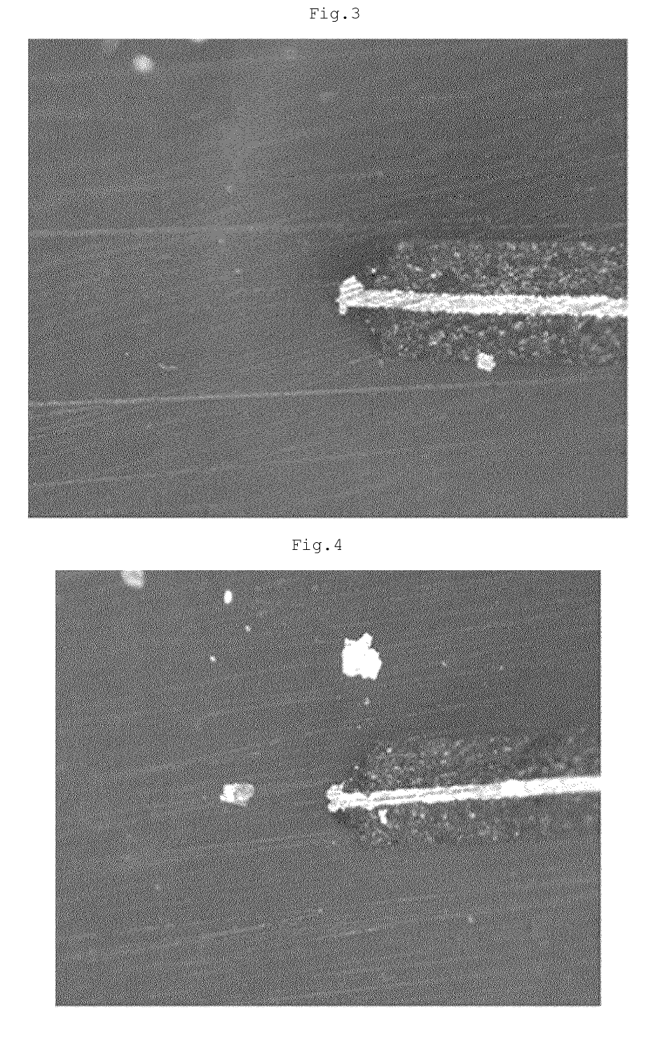

A photographic image of the cross section of an obtained positive electrode was taken by an optical microscope. FIG. 3 shows the obtained image.

### EXAMPLE 2

Positive electrodes were produced as in Example 1 except that a relative moving speed of 40 mm/sec of the laser beam and the positive electrode active substance layer was used to cut the aluminum foil. A photographic image of the cross section of an obtained positive electrode was taken by an optical microscope. FIG. 4 shows the obtained image.

### COMPARATIVE EXAMPLE 1

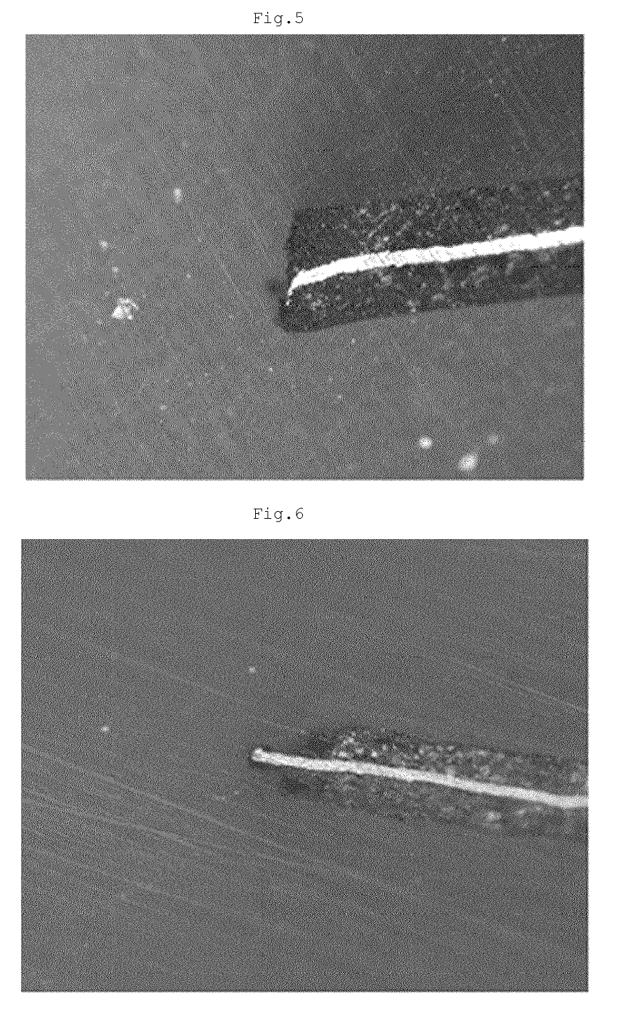

Positive electrodes were produced as in Example 1 except that the aluminum foil was cut by a metal mold. A photographic image of the cross section of an obtained positive electrode was taken as in Example 1. FIG. 5 shows the obtained image.

### COMPARATIVE EXAMPLE 2

A laser beam was irradiated as in Example 1 except that a relative moving speed of 60 mm/sec of the laser beam and the positive electrode active substance layer was used but the aluminum foil was not cut.

### EXAMPLE 3

Slurry was prepared from 49 mass portions of graphite having a number average particle diameter of 10 micrometer, 0.5 mass portions of acetylene black having a number average particle diameter of 7 micrometer, 3.5 mass portions of polyvinylidene fluoride and 47 mass portions of N-methyl-2-pyrrolidone.

The slurry was then applied to a copper foil having a thickness of 10 micrometer-thick and a width of 150 mm-wide that is used for collector intermittently across the entire width of the foil to produce 20 mm-long unapplied parts and 130 mm-long applied parts. Then, the slurry was dried to produce a 112 micrometer-thick negative electrode active substance layer.

A laser beam was irradiated twice onto the aluminum foil by means of a YAG laser of a laser wavelength of 1,060 nm under irradiation conditions including a spot diameter of 12 micrometer and a laser output of 20 W so as to form an electrode draw-out terminal having a width of 13 mm and a length of 15 mm on each of the unapplied part and cut the aluminum foil under the condition of relative moving speed of 20 mm/sec of the laser beam and the negative electrode active substance layer to produce negative electrodes with an application width of 69 mm and an application length of 130 mm.

A photographic image of the cross section of an obtained negative electrode was taken by an optical microscope. FIG. 6 shows the obtained image.

### EXAMPLE 5

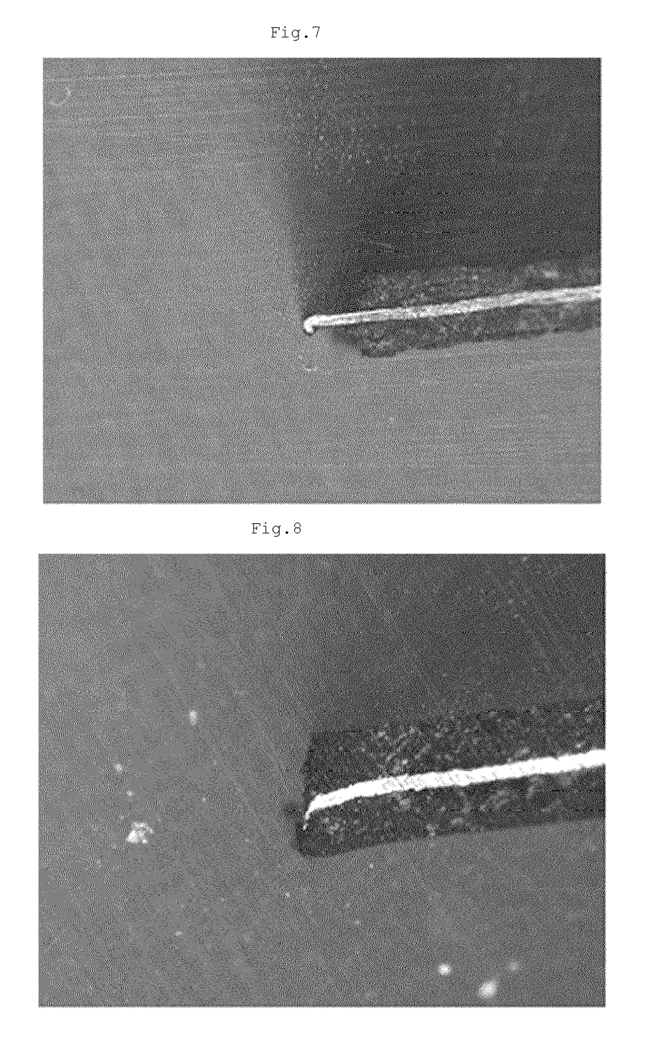

Positive electrodes were produced as in Example 1 except that a relative moving speed of 40 mm/sec of the laser beam and the positive electrode active substance layer was used to cut the aluminum foil. A photographic image of the cross section of an obtained positive electrode was taken. FIG. 7 shows the obtained image.

### COMPARATIVE EXAMPLE 3

Negative electrodes were produced as in Example 4 except that the aluminum foil was cut by a metal mold. A photographic image of the cross section of an obtained negative electrode was taken as in Example 1. FIG. 8 shows the obtained image.

### EXAMPLE 6

The positive electrodes prepared in Example 1 and the negative electrodes prepared in Example 4 were laid one on the other by way of separators having a three-layered structure of polypropylene/polyethylene/polypropylene to produce 15 sets of a positive electrode, a separator and a negative electrode. Then, a mixture solvent of ethylene carbonate and diethyl carbonate containing LiPF₆ of a concentration of 1M was injected as an electrolyte and subsequently contained in a film casing, which was then sealed to produce a lithium ion battery.

The obtained lithium ion battery was charged with a constant current of 0.25 C until the battery shows a voltage of 4.2 V and then further charged with the constant voltage for 8 hours. The voltage V1 was observed at the end of the charging process and the voltage V2 was observed after aging it for 3 days at 25 degrees C.

When the allowable voltage is defined to be 0.010V for the difference between V2 and V1 for a total number of tested sample batteries of 1,000, 11 sample batteries exceeded the allowable voltage.

### COMPARATIVE EXAMPLE 5

Lithium ion batteries were prepared as in Example 6 by using the positive electrodes obtained in Comparative Example 1 and the negative electrodes obtained in Comparative Example 3 and the battery performance was observed as in Example 6. 20 sample batteries exceeded the allowable voltage.

In a stacked secondary battery formed by laying plate-shaped positive electrodes and plate-shaped negative electrodes one on the other by way of separators according to the present invention, a collector is disposed at the front end of the end facet of each of the positive electrodes or the negative electrodes as viewed in a direction orthogonal relative to the stacking direction and has an active substance layer formed on the collector by applying slurry of particles of an active substance with a gap separating it from the front end or the active substance layer is made to show a thickness varying from the front end of the collectors toward the inside. Thus, no active substance comes off from the end section and the battery shows excellent characteristics including small self discharges.

What is claimed is:

1. A stacked secondary battery formed by laying plate-shaped positive electrodes and plate-shaped negative electrodes one on the other by way of separators, wherein a collector is disposed at the front end of the end facet of each of the positive electrodes or the negative electrodes as viewed in a direction orthogonal relative to the stacking direction and has an active substance layer formed on the collector by applying slurry of particles of an active substance with a gap separating it from the front end or the electrode active substance layer is made to show a thickness varying from the front end toward the inside.

2. The stacked secondary battery according to claim 1, wherein the collector has active substance layers formed on the opposite surfaces with a gap separating them from the front end or the electrode active substance layer may be made to show a thickness varying from the front end toward the inside.

3. The stacked secondary battery according to claim 1, wherein a molten and solidified section is formed on an outer peripheral part of the active substance layer as viewed in a direction orthogonal relative to the stacking direction.

4. The stacked secondary battery according to claim 2, wherein a molten and solidified section is formed on an outer peripheral part of the active substance layer as viewed in a direction orthogonal relative to the stacking direction.

5. A method of manufacturing a stacked secondary battery comprising:
forming at least either plate-shaped positive electrodes or plate-shaped negative electrodes by
forming an electrode active substance layer on each of the electrodes by applying an electrode active substance to a metal foil having a surface area greater than the surface of the electrode;
subsequently cutting the metal foil by irradiating a laser beam; and
removing a part of the electrode active substance layer running along the cut end facet of the metal foil by means of a thermal effect of the laser beam to form a molten and solidified section of the electrode active substance;
subsequently laying the plate-shaped positive electrodes and the plate-shaped negative electrodes by way of separators; and
sealing the stacked secondary battery.

6. The method according to claim 5, wherein a laser beam is irradiated only from one of the opposite sides of the electrode to remove a part of the electrode active substance layer running along the cut end facet of the metal foil by means of a thermal effect of the laser beam and to form molten and solidified sections of the electrode active substance on the respective surfaces of the electrode.
